(19) United States
(12) Patent Application Publication
(10) Pub. No.: US 2003/0157967 A1
(43) Pub. Date: Aug. 21, 2003

(54) Antenna conbiners

(76) Inventors: Simon Reza Saunders, Ash, Surrey (GB); Mauro Fiacco, Royston, Hertfordshire (GB)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/311,576

(22) PCT Filed: Jun. 20, 2001
(86) PCT No.: PCT/GB01/02722

(30) Foreign Application Priority Data
Jun. 23, 2000 (GB) 0015511.9

(51) Int. Cl. H04B 1/38

(52) U.S. Cl. 455/562; 455/83

(57) ABSTRACT

An antenna combiner for combining wideband antenna signals produced by a plurality of antenna elements of an adaptive antenna. The combiner includes a narrowband combiner which is used to derive weights from the wideband antenna signals. These weights are applied to the wideband antenna signals and the weighted signals are combined to form a composite signal.

This invention relates to antenna combiners.

The invention relates particularly to antenna combiners suitable for combining wideband antenna signals produced by a multiple receiver antenna arrangement, such as the antenna elements of an adaptive antenna, distributed antennas, smart antennas, intelligent antennas or any other antenna arrangement employing multiple detection in a wideband environment.

The invention also relates to wideband cellular systems incorporating one or more antenna combiners.

Antenna combiners according to the invention are intended to operate in a wideband environment for which the channel coherence bandwidth is typically small compared with the signal bandwidth.

In the case of an adaptive antenna the antenna beams produced by the antenna elements are able to deliver power to a localised region, and the antenna pattern can be used to reduce or null the effects of interference. This is described, for example, in “Beamforming: a versatile approach to spatial filtering” by B. D. Van Veen and K. M. Buckley, IEEE ASSP Magazine (Acoustics, Speech and Signal Processing), No 5, Vol 2, pp 4-24, April 1988. In an environment with multipath propagation, the receiver observes a large number of copies of the transmitted signal, each with a different time delay. The Gaussian statistics of the pseudo-noise (PN) sequence used to transmit the signal allows the receiver to resolve multipath components which are spaced by the order of a single chip period. This provides a form of multipath diversity which can be exploited using a RAKE receiver at the output of the code correlator in a CDMA scheme (see, for example, “A communication technique for multipath channels” by Price R. and Green P. E., Proc IRE, Vol 2, pp 555-570, March 1958) or a Viterbi Equaliser in a TDMA scheme. In a CDMA scheme, power control is needed on the reverse (down) link to minimise multiple access interference, as described in “Smart antenna arrays for CDMA systems” by Thomson J. S., Grant P. M. and Mulgrew B. IEEE Personal Communications, pp 16-25, October 1996. In a standard system a mobile transmitter far away from a cell's base station will be swamped by interference signals generated by users closer to the receiver, whereas in a distributed antenna system the distance between users and any receiving antenna will differ by a large amount and so a “near/far” problem arises due to distance dependent path loss.

The afore-mentioned schemes must all have the capability to reduce the effects of multipath interference and to control transmitted power. To that end, the wideband antenna signals produced by the multiple receiver antenna arrangement must be appropriately weighted and combined, and, hitherto, a wideband optimum combiner has commonly been employed. However, a wideband optimum combiner requires computationally complex processing which is inefficient and this presents a significant technical problem.

According to the invention there is provided an antenna combiner for combining wideband antenna signals produced by a plurality of antennas or antenna elements of a multiple-receiver antenna arrangement, comprising means, including a narrowband combiner, for deriving weights from said wideband antenna signals and signal processing means for applying said weights to wideband antenna signals produced by said antennas or antenna elements and forming a composite signal.

This scheme substitutes a more computationally manageable narrow band combiner for the ‘computationally hungry’ process of the wideband optimum combiner giving a significant reduction in computation power, thereby facilitating increased capacity and coverage, improved quality in the indoor and indoor/outdoor environment, interference reduction and power control capability.

An embodiment of the invention is now described, by way of example only, with reference to the accompanying drawings of which:

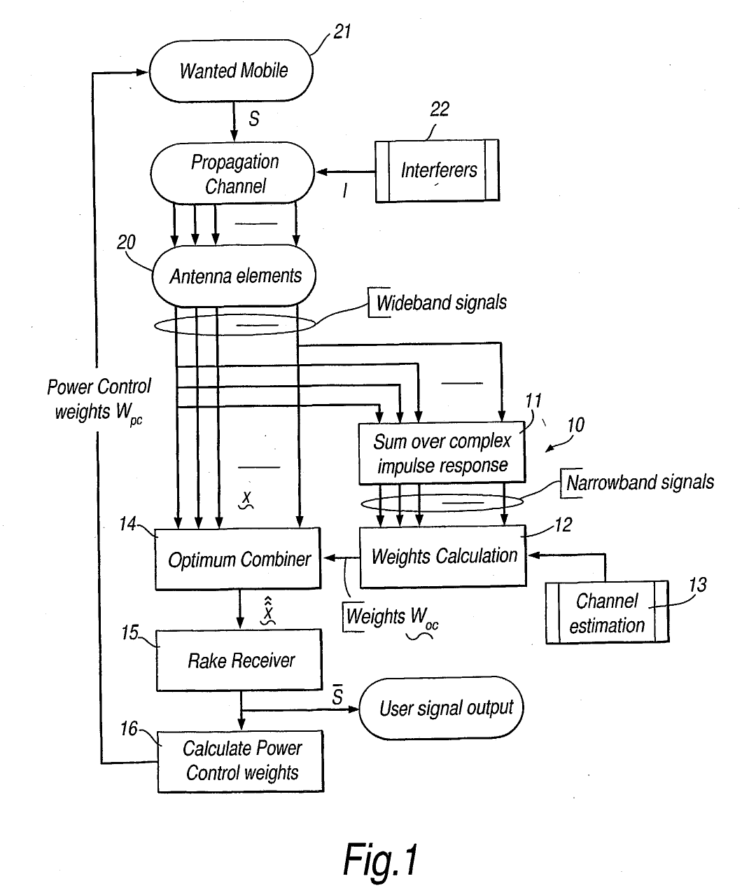

FIG. 1 is a block schematic diagram showing an antenna combiner according to the invention for use in a base station of a wideband cellular system, and

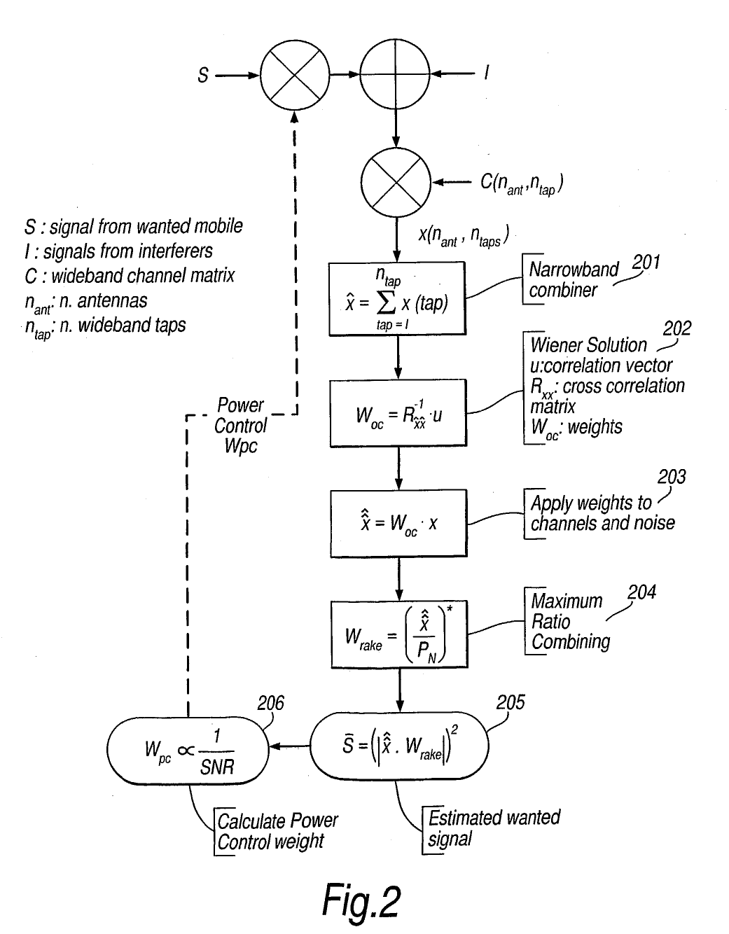

FIG. 2 is a flow diagram illustrating the processing steps carried out in the antenna combiner of FIG. 1

In this particular embodiment, the antenna combiner is described with reference to an adaptive antenna.

Referring to FIG. 1, the antenna combiner 10 receives wideband signals x from the antenna elements 20 of the adaptive antenna. The wideband signal output by each antenna element 20 includes three components; namely, a wanted signal S from a wanted mobile 21, interference signals I from sources of interference 22 and the wideband channel impulse response taps.

The combiner 10 includes a narrowband combiner 11, a weight calculation unit 12, a channel estimation unit 13 and an optimum combiner 14. As will be described with reference to FIG. 2, the narrowband combiner 11 calculates the sum of the wideband channel impulse response taps to generate a respective narrowband signal \hat{x} for each antenna element and the weight calculation unit 12 operates on each narrowband signal to calculate a respective weight for each antenna element. The optimum combiner 14 then applies the weights to the received wideband signals x and combines the weighted signals to produce a composite signal represented by the vector \hat{\hat{x}}.

The composite signal \hat{\hat{x}} is then supplied to a RAKE receiver 15 which estimates the wanted signal \overline{S}, referred to as the ‘user signal output’, and a power control unit 16 calculates power control weights W_{pc} from the signal-to-noise ratio (SNR) at the output of the RAKE receiver 15. These power control weights W_{pc} are then supplied to the wanted mobile 21 to facilitate control of the transmitted power.

This power control scheme has the advantage of being independent of the actual distance of the transmitter to the receiving antenna.

Referring now to FIG. 2, the antenna complex wideband input channels

$$x = [ \begin{matrix}{x}_{1} \\ {x}_{2} \\ ⋮ \\ {x}_{n}\end{matrix} ]$$

are combined in narrowband combiner 11 into a single narrowband signal \hat{x} (step 201):

$$\hat{x} = {\sum }_{tap = 1}^{{n}_{tap}} x ( tap )$$

where tap is the wideband channel tap number, there being one such narrowband signal \hat{x} for each antenna element 20.

A narrowband adaptive weight W_{oc} is then calculated for each antenna element 20 in weight calculation unit 12 (step 202) using the Wiener solution:

$${W}_{oc} = {R}_{{xx}^{′}}^{- 1} \cdot u$$

where Rₓₓ is the cross-correlation matrix of the estimated channel derived from unit 13 and u is the auto-correlation vector of the narrowband signal \hat{x} for the respective element.

The weights are then supplied to optimum combiner 14 which applies the weights to received wideband antenna signals x and adds the weighted signals to form a composite signal \hat{\hat{x}} (step 203) given by:

\hat{\hat{x}}=W_{oc}.x

The RAKE receiver 15 then subjects the composite signal \hat{\hat{x}} to maximum ratio combining (MRC) (step 204) and calculates the RAKE receiver weights (W_{RAKE}):

$${W}_{RAKE} = {( \frac{{x}^{\hat{\hat{}}}}{\sqrt{{P}_{N}}} )}^{*}$$

where the * represents the conjugate of the vector, and P_{N} is the noise power vector which is different for each branch, to allow for a different residual interference level for each tap.

The source signal power \overline{S} is estimated (step 205) as:

\overline{S}=(\hat{\hat{x}}.W_{RAKE})²

and finally the power control weights fed back (step 206) to the mobile 21 from unit 16 are inversely proportional to the SNR at the output of the RAKE receiver 15.

$${W}_{PC} ∝ \frac{1}{SNR}$$

1. The described scheme can be used in any system which employs a multiple receiver antenna arrangement, such as an adaptive antenna, distributed antennas, smart antennas, intelligent antennas or any other scheme employing multiple detection in a wideband environment.

2. The system can work for any wideband access scheme including: IS95, UMTS, CDMA2000 or any other cellular scheme employing a wideband scheme.

3. The scheme is particularly useful in Space Division Multiple Access schemes (SDMA).

4. The scheme is applicable to distributed antenna systems where conventional direction-of-arrival estimation schemes would otherwise fail. Distributed antenna schemes are those where mulitple antennas are separated by greater than one half-wavelength.

It will also be appreciated that the described processing is for use in a base station to support a user on the up-ink channel; alternatively, the processing could be provided to support a user on the down-link.

1. An antenna combiner for combining wideband antenna signals produced by a plurality of antennas or antenna elements of a multiple-receiver antenna arrangement comprising, means, including a narrowband combiner, for deriving weights from said wideband antenna signals, and signal processing means for applying said weights to wideband antenna signals produced by said antennas or antenna elements and forming a composite signal.

2. An antenna combiner as claimed in claim 1 wherein said signal processing means is an optimum combiner.

3. An antenna combiner as claimed in claim 1 or claim 2 wherein said narrowband combiner is arranged to sum the complex input responses of the antenna or antenna elements over a plurality of different channels (taps) to generate respective narrowband signals, and said weights are related to the auto-correlation vectors of said narrowband signals.

4. An antenna combiner as claimed in any one of claims 1 to 3 including means for subjecting the composite signal to optimum combining to generate receiver weights.

5. An antenna combiner as claimed in claim 4 including means for estimating signal power from said composite signal and said receiver weights.

6. An antenna combiner as claimed in claim 4 or claim 5 including means for generating power control weights from the output of said means for subjecting.

7. An antenna combiner as claimed in claim 6 wherein said power control weights are inversely proportioned to signal-to-noise ratio at the output of said means for subjecting.

8. An antenna combiner as claimed in any one of claims 5 to 7 wherein said receiver weights are RAKE receiver weights.

9. An antenna combiner as claimed in any one of claims 1 to 8 wherein said multiple-receiver antenna arrangement is an adaptive antenna comprising a plurality of antenna elements.

10. An antenna combiner substantially as herein described with reference to the accompanying drawings.

11. A wideband cellular system incorporating one of more antenna converter as claimed in any one of claims 1 to 10.

12. A system as claimed in claim 11 wherein the antenna converter is part of a system base station.
